(19) United States
(12) Patent Application Publication
(10) Pub. No.: US 2023/0030182 A1
(43) Pub. Date: Feb. 2, 2023

(54) BATTERY FOR ACHIEVING HIGH CYCLE LIFE AND ZINC UTILIZATION IN SECONDARY ZINC ANODES USING ELECTROCOAGULANTS

(71) Applicant: RESEARCH FOUNDATION OF THE CITY UNIVERSITY OF NEW YORK, New York, NY (US)

(72) Inventors: Gautam G. YADAV, New York, NY (US); Xia WEI, New York, NY (US); Joshua GALLAWAY, New York, NY (US); Michael NYCE, New York, NY (US); Sanjoy BANERJEE, New York, NY (US)

(21) Appl. No.: 17/788,822

(22) PCT Filed: Jan. 22, 2021
(86) PCT No.: PCT/US2021/014627

§ 371 Date: Jun. 24, 2022

Related U.S. Application Data
(60) Provisional application No. 62/964,940, filed on Jan. 23, 2020.

(51) Int. Cl. H01M 4/62; H01M 4/24

(52) U.S. Cl. CPC H01M 4/628; H01M 4/244; H01M 2004/027

(57) ABSTRACT

A battery comprises a housing, an electrolyte disposed in the housing, a cathode disposed in the housing, an anode disposed in the housing and comprising an anode material comprising: zinc or zinc oxide, an electrocoagulant material selected from the group consisting of: aluminum, iron, titanium, calcium, zirconium, a hydroxide thereof, a salt thereof, an oxide thereof, and a combination thereof, and a binder.

### CROSS-REFERENCE TO RELATED APPLICATIONS

This application claims the benefit of: U.S. Provisional Application No. 62/964,940 filed on Jan. 23, 2020 and entitled “Battery for Achieving High Cycle Life and Zinc Utilization in Secondary Zinc Anodes Using Electrocoagulants”, which is incorporated herein by reference in its entirety for all purposes.

### STATEMENT OF FEDERALLY SPONSORED RESEARCH OR DEVELOPMENT

This invention was made with Government support under grant number DEAR0000150 awarded by the U.S. Department of Energy. The government has certain rights in the invention.

### BACKGROUND

Zinc anode batteries like alkaline manganese dioxide (MnO₂)-zinc, nickel (Ni)-zinc, silver (Ag)-zinc and zinc-air batteries have very high energy densities that could be very useful for a number of applications like grid-storage, cell phones and electric vehicles. However, the use of zinc has been relegated to primary batteries due to the irreversible characteristics of a zinc (Zn) anode, where the anode has the tendency to dissolve and relocate to different regions of the electrode to create a phenomenon called shape-change, form irreversible oxides like zinc oxide at the end of discharge, and form dendritic structures that puncture the separator to create a short circuit.

The high energy density of the alkaline cell stems from the high capacity of its active materials and the high overall cell potential caused due to the electrochemical activity of zinc at a lower potential. Zinc has a theoretical capacity of 820 mAh/g, which originates from its two electron (2e) reaction. Zinc undergoes the 2e⁻ reaction through a dissolution-precipitation process to form zinc oxide (ZnO) as the discharged product. In a rechargeable system, typically the zinc oxide should undergo the dissolution-precipitation process reversibly to form charged zinc, however, the electrical resistivity of zinc oxide impedes this process. The dissolved zinc in alkaline solution is called zincate [Zn(OH)₄²⁻], which has a tendency to form immediately when zinc is in contact with alkaline electrolyte. Due to the high density of zinc, the zincate ions never deposit at the same region of the electrode and this tends to cause the shape-change phenomenon. Also, in MnO₂—Zn batteries the zincate ions interfere in the MnO₂ reactions and poison the cathode to form irreversible hetaerolite (ZnMn₂O₄). To mitigate some of these problems, researchers have resorted to cycling the Zn anodes to less than 8% of the theoretical capacity to increase the cycle life of the cell. However, reducing the theoretical capacity also limits the overall energy density of the cell and thus, reducing its use in many applications.

Many researchers have tried in the past to solve some of the aforementioned problems. For example, U.S. Pat. No. 5,863,676 used an anode containing calcium zincate, which is a mixture of calcium hydroxide and zinc oxide to create an insoluble structure. Calcium zincate is supposed to trap the dissolved zincate ions and prevent it from migrating towards the bulk electrolyte, therefore preventing shape-change and dendrite formation. The best cycle life reported in this reference is ˜170 cycles. However, the content of zinc in the electrodes is low, which reduces the energy density of the cell. Many calcium zincate patents exist of which some of them relate to calcium zincate synthesis procedure. Other researchers have tried to use a number of additives containing Bi, In, etc. to reduce corrosion and gassing in Zn anode alkaline batteries, however, none have tried to improve the cycle life. Maintaining a cycle life (e.g., >150 cycles) and a Zn utilization or depth of discharge (DOD, DOD or utilization=Zn anode capacity delivered/Zn theoretical capacity*100) of >10% is an endeavor which has not been achieved successfully.

### SUMMARY

In some embodiments, a battery comprises a housing, an electrolyte disposed in the housing, a cathode disposed in the housing, an anode disposed in the housing and comprising an anode material comprising: zinc or zinc oxide, an electrocoagulant material selected from the group consisting of: aluminum, iron, titanium, calcium, zirconium, a hydroxide thereof, a salt thereof, an oxide thereof, or a combination thereof, and a binder.

In some embodiments, a battery comprises a housing, an electrolyte disposed in the housing, wherein the electrolyte comprises an electrocoagulant material selected from the group consisting of: aluminum, iron, titanium, calcium, zirconium, a hydroxide thereof, a salt thereof, an oxide thereof, and a combination thereof, a cathode disposed in the housing, an anode disposed in the housing and comprising an anode material comprising: zinc or zinc oxide, and a binder.

In some embodiments, a method of operating a battery comprises discharging a battery, recharging the battery, coagulating one or more reaction products of the zinc or zinc oxide with the electrocoagulant material, and retaining the one or more reaction products of the zinc or zinc oxide at or near the anode during the discharging, recharging, or both using the electrocoagulant material. The battery comprises a housing, an electrolyte disposed in the housing, a cathode disposed in the housing, an anode disposed in the housing and comprising an anode material comprising: zinc or zinc oxide, an electrocoagulant material selected from the group consisting of: aluminum, iron, titanium, calcium, zirconium, a hydroxide thereof, a salt thereof, an oxide thereof, and a combination thereof, and a binder.

These and other features will be more clearly understood from the following detailed description taken in conjunction with the accompanying claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIGS. 1A-1D show examples different battery designs and configurations.

FIG. 2 shows the cycle life and Zn utilization of electrodes containing aluminum hydroxide [Al(OH)₃] compared to a baseline electrode as described with respect to Example 1.

FIGS. 3A, 3B, and 3C show the potential and current-time curves of the electrode containing the Al(OH)₃ as an electrocoagulant additive versus the baseline electrode as described with respect to Example 1.

FIGS. 4A, 4B, and 4C show the beneficial effects of adding a conductive agent like copper (Cu) powder to the electrode containing Al(OH)₃ as described with respect to Example 2.

### DETAILED DESCRIPTION

In this disclosure, the terms “negative electrode” and “anode” are both used to mean “negative electrode.” Likewise, the terms “positive electrode” and “cathode” are both used to mean “positive electrode.” Reference to an “electrode” alone can refer to the anode, cathode, or both. Reference to the term “primary battery” (e.g., “primary battery,” “primary electrochemical cell,” or “primary cell”), refers to a cell or battery that after a single discharge is disposed of and replaced. Reference to the term “secondary battery” (e.g., “secondary battery,” “secondary electrochemical cell,” or “secondary cell”), refers to a cell or battery that can be recharged one or more times and reused.

The present disclosure is with regards to the development of a Zn-anode rechargeable electrode. This electrode can be used in various rechargeable batteries that use a Zn-anode. Applications for such a battery could be in grid-scale energy storage, traction batteries, aerospace applications, telecommunications, uninterruptible power supply (UPS), medical applications, etc. to name a few.

As described herein, the battery can comprise an electrocoagulant. Electrocoagulants, which can also be referred to as simply coagulants herein, can be used in some instances in an electrocoagulation process to treat water and wastewater to remove pollutants, pesticides, oil, etc. In an electrocoagulation wastewater process, sacrificial electrodes are used where an electric current passing through the electrodes dissolves the electrodes to generate metal ions or coagulating agents that coagulate the pollutants in water. Example of electrocoagulants can include, but are not limited to, aluminum, iron, manganese (e.g. MnO₂ and Mn₃O₄), titanium (e.g. TiO₂), calcium, and/or zirconium as well as the electrolysis products of such elements such as oxides, hydroxides, salts, and the like. The dissolved coagulants generate a number of aqueous complex ions that increase the coagulation efficiency. For example, aluminum (Al) in water can produce various compounds such as Al(OH)²⁺, Al₂(OH)₂⁴⁺, Al₆(OH)₁₅³⁺, Al₁₃(OH)₃₄⁵⁺, Al(H₂O)₆³⁺, Al(H₂O)₅OH²⁺ and Al(H₂O)₄OH⁺.

In an alkaline battery system, the zincate ions can be viewed as dissolved impurities that poison the cathode, and the loss of the zinc in the zincate ions from the localized vicinity of the anodes results in loss of capacity of the Zn anodes. In some instances, aluminum has been used as a corrosion inhibiting agent in Zn anode batteries. For example, aluminum sulfate and aluminum potassium sulfate additives can be used to reduce the hydrogen gassing rates in the cell that resulted from Zn corrosion. However, aluminum or its other compound derivatives have not been used as electrocoagulants or coagulants to localize the zincate ions near the vicinity of the electrode and prevent zinc migration. Also, the presence of aluminum with zinc oxide can increase the conductivity of the oxide, and thus, increase the reversibility of zinc oxide to zinc in its charged state.

In this disclosure, the addition of electrocoagulants or compound derivative(s) of coagulants like aluminum hydroxide [Al(OH)₃] are provided that increase the Zn utilization to 15-40% and increase the cycle life to 200-1000 cycles.

A rechargeable Zn anode alkaline battery is also described. The battery includes a cathode material and an anode material with zinc or zinc oxide, a coagulant and a binder. In some embodiments, coagulants can comprise aluminum or compounds, derivatives, and/or salts of aluminum, or iron or compounds and/or derivatives of iron, or compounds containing aluminum and/or iron. In some of the embodiments, a conductive additive like copper or compounds, derivatives, oxides, and/or salts of copper could be added to reduce the charge transfer resistance of the electrode. An advantage that may be realized in the practice of some disclosed embodiments of the battery is that a Zn anode battery is rendered rechargeable for longer cycle life and at high depths of discharge.

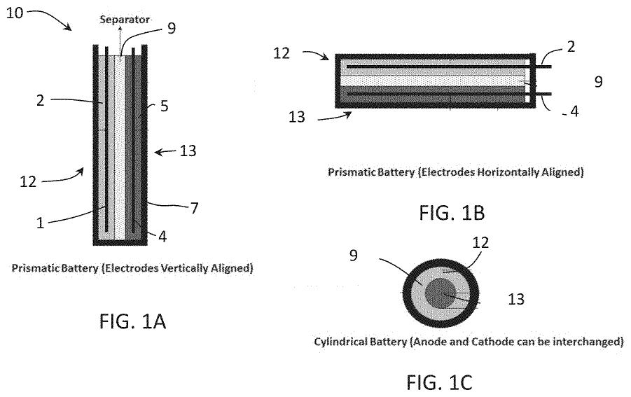

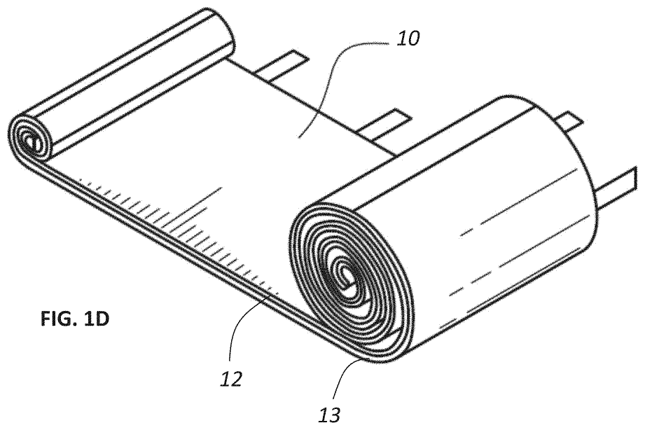

Some embodiments of the cell or battery design where this rechargeable anode could be used is shown in FIGS. 1A-1D. A prismatic and cylindrical battery design is shown, but it is not limited to these battery form factors. The battery comprises a cathode, an anode, electrolyte, and optionally, a separator. The designs shown are just a guide and are not limited to the designs shown in FIGS. 1A-1D.

Referring to FIGS. 1A-1C, a cell or battery 10 can have a housing 7, a cathode 12, which can include a cathode current collector 1 and a cathode material 2, and an anode 13. In some embodiments, the anode 13 can comprise an anode current collector 4, and an anode material 5. It is noted that the scale of the components in FIGS. 1A-1C may not be exact as the features are illustrates to clearly show the anode 13 and the cathode 12 with the separator 9. FIGS. 1A-1B show a prismatic battery arrangement having a single anode 13 and cathode 12. The prismatic configuration can have a number of form factors such as a vertical configuration as shown in FIG. 1A or a horizontal configuration as shown in FIG. 1B. In another embodiment, the battery can be a cylindrical battery having the electrodes arranged concentrically as shown in FIG. 1C or in a rolled configuration as shown in FIG. 1D in which the anode 13 and cathode 12 are layered and then rolled to form a jelly roll configuration. The cathode current collector 1 and cathode material 2 are collectively called either the cathode 12 or the positive electrode 12, as shown in FIG. 1A. Similarly, the anode material 5 with the optional anode current collector 4 can be collectively called either the anode 13 or the negative electrode 13. An electrolyte can be in contact with the cathode 12 and the anode 13 within the housing 7.

In some embodiments, the battery 10 can comprise one or more cathodes 12 and one or more anodes 13, which can be present in any configuration or form factor. When a plurality of anodes 13 and/or a plurality of cathodes 12 are present, the electrodes can be configured in a layered configuration such that the electrodes alternate (e.g., anode, cathode, anode, etc.). Any number of anodes 13 and/or cathodes 12 can be present to provide a desired capacity and/or output voltage. In the jellyroll configuration (e.g., as shown in FIG. 1D), the battery 10 may only have one cathode 12 and one anode 13 in a rolled configuration such that a cross section of the battery 10 includes a layered configuration of alternating electrodes, though a plurality of cathodes 12 and anodes 13 can be used in a layered configuration and rolled to form the rolled configuration with alternating layers.

In an embodiment, housing 7 comprises a molded box or container that is generally non-reactive with respect to the electrolyte solutions in the battery 10. In an embodiment, the housing 7 comprises a polymer (e.g., a polypropylene molded box, an acrylic polymer molded box, etc.), a coated metal, or the like.

The cathode 12 can comprise a mixture of components including an electrochemically active material. Additional components such as a binder, a conductive material, and/or one or more additional components can also be optionally included that can serve to improve the lifespan, rechargeability, and electrochemical properties of the cathode 12. The cathode used can comprise manganese dioxide for Zn/MnO₂ battery or air with manganese dioxide as the catalyst for the bifunctional electrocatalytic reactions in a Zn/air battery. In some aspects, the cathode used can comprise nickel oxyhydroxide (NiOOH), silver (Ag), copper (Cu), bromine (Br), or combinations thereof.

In some embodiments, the cathode material 2 can be based on one or many polymorphs of MnO₂, including electrolytic (EMD), α-MnO₂, β-MnO₂, γ-MnO₂, δ-MnO₂, ε-MnO₂, λ-MnO₂, and/or chemically modified manganese dioxide. Other forms of MnO₂ can also be present such as hydrated MnO₂, pyrolusite, birnessite, ramsdellite, hollandite, romanechite, todorkite, lithiophorite, chalcophanite, sodium or potassium rich birnessite, cryptomelane, buserite, manganese oxyhydroxide (MnOOH), α-MnOOH, γ-MnOOH, β-MnOOH, manganese hydroxide [Mn(OH)₂], partially or fully protonated manganese dioxide, Mn₃O₄, Mn₂O₃, bixbyite, MnO, lithiated manganese dioxide (LiMn₂O₄, Li₂MnO₃), CuMn₂O₄, aluminum manganese oxide, zinc manganese dioxide, bismuth manganese oxide, copper intercalated birnessite, copper intercalated bismuth birnessite, tin doped manganese oxide, magnesium manganese oxide, or any combination thereof. In general, the cycled form of manganese dioxide in the cathode can have a layered configuration, which in some embodiment can comprise δ-MnO₂ that is interchangeably referred to as birnessite. If non-birnessite polymorphic forms of manganese dioxide are used, these can be converted to birnessite in-situ by one or more conditioning cycles as described in more details below. For example, a full or partial discharge to the end of the MnO₂ second electron stage (e.g., between about 20% to about 100% of the 2^{nd} electron capacity of the cathode) may be performed and subsequently recharging back to its Mn⁴⁺ state, resulting in birnessite-phase manganese dioxide.

In some embodiments, the cathode composition is 1-90 wt. % manganese dioxide, 0-30 wt. % bismuth or bismuth-based compounds, 0-50 wt. % copper or copper-based compounds, 1-90 wt. % conductive additive, and 0-10 wt. % binder.

In some embodiments, a binder can be used with the cathode material 2. In some embodiments, the binder comprises water-soluble cellulose-based hydrogels, which can be used as thickeners and strong binders, and have been cross-linked with good mechanical strength and with conductive polymers. The binder may also be a cellulose film sold as cellophane. The binders can be made by physically cross-linking the water-soluble cellulose-based hydrogels with a polymer through repeated cooling and thawing cycles. In some embodiments, the binder can comprise a 0-10 wt. % methyl cellulose (MC) and/or carboxymethyl cellulose (CMC) solution cross-linked with 0-10 wt. % polyvinyl alcohol (PVA) on an equal volume basis. The binder, compared to the traditionally-used polytetrafluoroethylene (PTFE), shows superior performance. PTFE is a very resistive material, but its use in the industry has been widespread due to its good rollable properties. This, however, does not rule out using PTFE as a binder. Mixtures of PTFE with the aqueous binder and some conductive carbon can be used to create rollable binders. Using the aqueous-based binder can help in achieving a significant fraction of the two-electron capacity with minimal capacity loss over many cycles. In some embodiments, the binder can be water-based, have superior water retention capabilities, adhesion properties, and help to maintain the conductivity relative to an identical cathode using a PTFE binder instead. Examples of suitable water-based hydrogels can include, but are not limited to, methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose, hydroxyethyl cellulose (HEC), and combinations thereof. Examples of crosslinking polymers include polyvinyl alcohol, polyvinylacetate, polyaniline, polyvinylpyrrolidone, polyvinylidene fluoride, polypyrrole, and combinations thereof. In some embodiments, a 0-10 wt. % solution of water-cased cellulose hydrogen can be cross linked with a 0-10 wt. % solution of crosslinking polymers by, for example, repeated freeze/thaw cycles, radiation treatment, and/or chemical agents (e.g. epichlorohydrin). The aqueous binder may be mixed with 0-5% wt. % PTFE to improve manufacturability. The binder can be present in a concentration of between about 0-10 wt. %.

The cathode material 2 can also comprise additional elements. The additional elements can be included in the cathode material including a bismuth compound and/or copper/copper compounds, which together allow improved galvanostatic battery cycling of the cathode. When present as birnessite, the copper and/or bismuth can be incorporated into the layered nanostructure of the birnessite. The resulting birnessite cathode material can exhibit improved cycling and long term performance with the copper and bismuth incorporated into the crystal and nanostructure of the birnessite.

The bismuth or bismuth-based compounds are used to access greater capacity (20-100% of 617 mAh/g) from the manganese dioxide 2^{nd} electron capacity. They are used in batteries where manganese dioxide is usually the layered-phase birnessite. It is also used in batteries where the manganese dioxide can be any polymorph and discharging it completely to 617 mAh/g and charging it back results in the formation of birnessite. In batteries, where accessing 0-100% of 310 mAh/g of the manganese dioxide capacity (e.g., accessing the 1^{st} electron capacity with a material such as EMD), bismuth or bismuth-based compounds may or may not be used.

The bismuth compound can be incorporated into the cathode 12 as an inorganic or organic salt of bismuth (oxidation states 5, 4, 3, 2, or 1), as a bismuth oxide, or as bismuth metal (i.e. elemental bismuth). Examples of bismuth compounds include bismuth oxide, bismuth chloride, bismuth bromide, bismuth fluoride, bismuth iodide, bismuth sulfate, bismuth nitrate, bismuth trichloride, bismuth citrate, bismuth telluride, bismuth selenide, bismuth subsalicylate, bismuth neodecanoate, bismuth carbonate, bismuth subgallate, bismuth strontium calcium copper oxide, bismuth acetate, bismuth trifluoromethanesulfonate, bismuth nitrate oxide, bismuth gallate hydrate, bismuth phosphate, bismuth cobalt zinc oxide, bismuth sulphite agar, bismuth oxychloride, bismuth aluminate hydrate, bismuth tungsten oxide, bismuth lead strontium calcium copper oxide, bismuth antimonide, bismuth antimony telluride, bismuth oxide yttria stabilized, bismuth-lead alloy, ammonium bismuth citrate, 2-napthol bismuth salt, duchloritri(o-tolyl)bismuth, dichlordiphenyl(p-tolyl)bismuth, or triphenylbismuth.

The copper or copper-based compounds are used to access greater capacity (20-100% of 617 mAh/g) from the manganese dioxide 2^{nd} electron capacity. They are used in batteries where manganese dioxide is usually the layered-phase birnessite. It is also used in batteries where the manganese dioxide can be any polymorph and discharging it completely to 617 mAh/g and charging it back results in the formation of birnessite. It is desirable to be used in batteries accessing 20-100% of 617 mAh/g for thousands of cycles as Cu helps in the rechargeability and reducing the charge transfer resistance. In batteries, where accessing 0-100% of 310 mAh/g of the manganese dioxide capacity (e.g., accessing the 1^{st} electron capacity with a material such as EMD), copper or copper-based compounds may or may not be used. The effect of copper is to alter the oxidation and reduction voltages of bismuth. This results in a cathode with full reversibility during galvanostatic cycling, as compared to a bismuth-modified MnO₂ which cannot withstand galvanostatic cycling as well.

The copper compound can be incorporated into the cathode 12 as an organic or inorganic salt of copper (oxidation states 1, 2, 3, or 4), as a copper oxide, or as copper metal (i.e., elemental copper). The copper compound can be present in a concentration between about 1-70 wt. % of the weight of the cathode material 2. In some embodiments, the copper compound is present in a concentration between about 5-50 wt. % of the weight of the cathode material 2. In other embodiments, the copper compound is present in a concentration between about 10-50 wt. % of the weight of the cathode material 2. In yet other embodiments, the copper compound is present in a concentration between about 5-20 wt. % of the weight of the cathode material 2. Examples of copper compounds include copper and copper salts such as copper aluminum oxide, copper (I) oxide, copper (II) oxide and/or copper salts in a +1, +2, +3, or +4 oxidation state including, but not limited to, copper nitrate, copper sulfate, copper chloride, etc.

The addition of a conductive additive allows higher loadings of MnO₂ to be used that increase gravimetric and volumetric energy density. The conductive additive can be present in a concentration between about 1-30 wt. %. Example of a conductive additive include conductive carbon including single walled carbon nanotubes, multiwalled carbon nanotubes, graphene, carbon blacks of various surface areas, and others that have specifically very high surface area and conductivity. Higher loadings of the MnO₂ in the mixed material electrode are, in some embodiments, desirable to increase the energy density. Other examples of conductive carbon include TIMREX Primary Synthetic Graphite (all types), TIMREX Natural Flake Graphite (all types), TIMREX MB, MK, MX, KC, B, LB Grades (examples, KS15, KS44, KC44, MB15, MB25, MK15, MK25, MK44, MX15, MX25, BNB90, LB family) TIMREX Dispersions; ENASCO 150G, 210G, 250G, 260G, 350G, 150P, 250P; SUPER P, SUPER P Li, carbon black (examples include Ketj enblack EC-300J, Ketj enblack EC-600JD, Ketj enblack EC-600JD powder), acetylene black, carbon nanotubes (single or multi-walled), graphene, graphyne, graphene oxide, Zenyatta graphite and combinations thereof.

In some embodiments, the conductive additive can have a particle size range from about 1 to about 50 microns, or between about 2 and about 30 microns, or between about 5 and about 15 microns. The total conductive additive mass percentage in the cathode material 2 can range from about 5% to about 99% or between about 10% to about 80%. In some embodiments, the electroactive component in the cathode material 2 can be between 1 and 99 wt. % of the weight of the cathode material 2, and the conductive additive can be between 1 and 99 wt. %.

In some embodiments, the cathode material 2 can also comprise a conductive component. The addition of a conductive component such as metal additives to the cathode material 2 may be accomplished by addition of one or more metal powders such as nickel powder to the cathode material 2. The conductive metal component can be present in a concentration of between about 0-30 wt. % in the cathode material 2. The conductive metal component may be, for example, nickel, copper, silver, gold, tin, cobalt, antimony, brass, bronze, aluminum, calcium, iron, or platinum. In one embodiment, the conductive metal component is a powder. In some embodiments, the conductive component can be added as an oxide and/or salt. For example, the conductive component can be cobalt oxide, cobalt hydroxide, lead oxide, lead hydroxide, or a combination thereof. In some embodiments, a second conductive metal component is added to act as a supportive conductive backbone for the first and second electron reactions to take place. The second electron reaction has a dissolution-precipitation reaction where Mn³⁺ ions become soluble in the electrolyte and precipitate out on the materials such as graphite resulting in an electrochemical reaction and the formation of manganese hydroxide [Mn(OH)₂] which is non-conductive. This ultimately results in a capacity fade in subsequent cycles. Suitable conductive components that can help to reduce the solubility of the manganese ions include transition metals like Ni, Co, Fe, Ti and metals like Ag, Au, Al, Ca. Oxides and salts of such metals are also suitable. Transition metals like Co can also help in reducing the solubility of Mn³⁺ ions. Such conductive metal components may be incorporated into the electrode by chemical means or by physical means (e.g. ball milling, mortar/pestle, spex mixture). An example of such an electrode comprises 5-95% birnessite, 5-95% conductive carbon, 0-50% conductive component (e.g., a conductive metal), and 1-10% binder.

The cathode material 2 can be formed on a cathode current collector 1, which can be formed from a conductive material that serves as an electrical connection between the cathode material and an external electrical connection or connections. In some embodiments, the cathode current collector 1 can be made from, for example, carbon, lead, nickel, steel (e.g., stainless steel, etc.), nickel-coated steel, nickel plated copper, tin-coated steel, copper plated nickel, silver coated copper, copper, magnesium, aluminum, tin, iron, platinum, silver, gold, titanium, bismuth, titanium, half nickel and half copper, or any combination thereof. In some embodiments, the current collector 1 can comprise a carbon felt or conductive polymer mesh. The cathode current collector 1 may be formed into a mesh (e.g., an expanded mesh, woven mesh, etc.), perforated metal, foam, foil, felt, fibrous architecture, porous block architecture, perforated foil, wire screen, a wrapped assembly, or any combination thereof. In some embodiments, the current collector can be formed into or form a part of a pocket assembly, where the pocket can hold the cathode material 2 within the cathode current collector 1. A tab (e.g., a portion of the cathode current collector 1 extending outside of the cathode material 2 as shown at the top of the cathode 12 in FIG. 1A) can be coupled to the current collector to provide an electrical connection between an external source and the current collector.

When the anode comprises zinc, the anode 13 can comprise zinc in the form of Zn metal (100 wt. %), zinc oxide, and/or Zn powder of various morphologies (sphere, fiber, wire, tube, sheet, etc.) and sizes. An anode containing Zn powder as the active material can comprise 1-99 wt. % Zn powder, 0-99 wt. % zinc oxide (ZnO) and the remaining wt. % as binder. In some embodiment, the Zn may be present in the anode material 5 in an amount of from about 50 wt. % to about 90 wt. %, alternatively from about 60 wt. % to about 80 wt. %, or alternatively from about 65 wt. % to about 75 wt. %, based on the total weight of the anode material. In some embodiments conductive additives, gas inhibitor(s), and/or complexing additives like lithium, copper (Cu), indium, iron, cadmium, bismuth, aluminum, calcium, oxides thereof, hydroxides thereof, or any combination thereof can be added in 1-20 wt. %.

In some embodiments, the anode material 5 can comprise zinc oxide (ZnO), which may be present in an amount of from about 5 wt. % to about 20 wt. %, alternatively from about 5 wt. % to about 15 wt. %, or alternatively from about 5 wt. % to about 10 wt. %, based on the total weight of anode material. As will be appreciated by one of skill in the art, and with the help of this disclosure, the purpose of the ZnO in the anode mixture is to provide a source of Zn during the recharging steps, and the zinc present can be converted between zinc and zinc oxide during charging and discharging phases.

In some embodiments, an electrically conductive material may be optionally present in the anode material 5 in an amount of from about 5 wt. % to about 20 wt. %, alternatively from about 5 wt. % to about 15 wt. %, alternatively from about 5 wt. % to about 10 wt. %, or in some aspects between 0% and 10 wt. % based on the total weight of the anode material 5. As will be appreciated by one of skill in the art, and with the help of this disclosure, the electrically conductive material can be used in the anode mixture as a conducting agent, e.g., to enhance the overall electric conductivity of the anode mixture. Non-limiting examples of electrically conductive material suitable for use can include any of the conductive carbons described herein such as carbon, graphite, graphite powder, graphite powder flakes, graphite powder spheroids, carbon black, activated carbon, conductive carbon, amorphous carbon, glassy carbon, and the like, or combinations thereof. The conductive carbons can be used alone or with the metallic coating or layer. The conductive material can also comprise any of the conductive carbon materials described with respect to the cathode material including, but not limited to, acetylene black, single walled carbon nanotubes, multi-walled carbon nanotubes, graphene, graphyne, or any combinations thereof (e.g., with or without the metallic coating(s)).

In some aspects, a conductive metal additive can be included in the anode. The use of the conductive metal additive is another possibility of increasing conductivity of the electrode and reducing charge transfer resistance. The conductive metal additive can be present in a concentration of 0-10 wt. %. The conductive metal additive may be, for example, nickel, copper, silver, gold, brass, bronze, cobalt, nickel-cobalt, nickel-copper, bismuth, bismuth oxide and tin. The conductive metal additive can be plated using electroless plating solution, where a reducing agent reduces the conductive metal ions in the solution onto the anode mix or Zn or derivatives of Zn. The electroless plating method does not require any power source or anode to plate the conductive metal ions. The conductive metal additive can also be added as powders in their metallic state, as salts or salt-derivatives, and/or as oxides. A combination of two or more metallic additives can also be used.

The anode material 5 may also comprise an optional binder. Generally, a binder functions to hold the electroactive material particles together and in contact with the current collector. The binder can be present in a concentration of 0-10 wt. %. The binders may comprise water-soluble cellulose-based hydrogels like methyl cellulose (MC), carboxymethyl cellulose (CMC), hydroypropyl cellulose (HPH), hydroypropylmethyl cellulose (HPMC), hydroxethylmethyl cellulose (HEMC), carboxymethylhydroxyethyl cellulose and hydroxyethyl cellulose (HEC), which were used as thickeners and strong binders, and have been cross-linked with good mechanical strength and with conductive polymers like polyvinyl alcohol, polyvinylacetate, polyaniline, polyvinylpyrrolidone, polyvinylidene fluoride and polypyrrole. The binder may also be a cellulose film sold as cellophane. The binder may also be PTFE, which is a very resistive material, but its use in the industry has been widespread due to its good rollable properties. In some embodiments, the binder may be present in anode material in an amount of from about 2 wt. % to about 10 wt. %, alternatively from about 2 wt. % to about 7 wt. %, or alternatively from about 4 wt. % to about 6 wt. %, based on the total weight of the anode material 5.

In some embodiments, the anode material 5 can be used by itself without a separate anode current collector 4, though a tab or other electrical connection can still be provided to the anode material 5. In this embodiment, the anode material may have the form or architecture of a foil, a mesh, a perforated layer, a foam, a felt, or a powder. For example, the anode can comprise a metal foil electrode, a mesh electrode, or a perforated metal foil electrode. In some embodiments, the anode 13 can comprise an optional anode current collector 4. The anode current collector 4 can be used with an anode 13, including any of those described with respect to the cathode 12. For example, the anode current collector may be a conductive material, for example, nickel, nickel-coated steel, tin-coated steel, silver coated copper, copper plated nickel, nickel plated copper, copper or similar material, and the anode current collector may be formed into an expanded mesh, perforated mesh, foil or a wrapped assembly.

The rechargeable Zn-anode capable of accessing high DOD from 0-50% comprising of zinc or a derivative of zinc-based compound, coagulant additive, conductive additive and binder. The anode comprises of 1-30 wt. % coagulant additive, 0-10 wt. % binder, 0-10 wt. % conductive additive and the balance zinc or derivatives of zinc-based compound.

The coagulant additives can be in the form of substrates, powder additives to the electrode, and/or as additive to the electrolyte, where it can be activated through an electrochemical process by passage of a current. Example of electrocoagulants can include, but are not limited to, aluminum, iron, manganese (e.g. MnO₂ and Mn₃O₄), titanium (e.g. TiO₂), calcium, and/or zirconium as well as the electrolysis products of such elements such as oxides, hydroxides, salts, and the like. The dissolved coagulants generate a number of aqueous complex ions that increase the coagulation efficiency. For example, aluminum (Al) in water can produce various compounds such as Al(OH)²⁺, Al₂(OH)₂⁴⁺, Al₆(OH)₁₅³⁺, Al₁₃(OH)₃₄⁵⁺, Al(H₂O)₆³⁺, Al(H₂O)₅OH²⁺ and Al(H₂O)₄OH⁺.

In some aspects, the coagulant can comprise, but is not limited to, aluminum, aluminum hydroxide, aluminum oxide, aluminum oxinate, aluminum monostearate, aluminum hydroxide hydrate, aluminum silicate, bismuth aluminate hydrate, aluminum titanate, strontium aluminate, lithium aluminate, strontium lanthanum aluminate, sodium aluminate and yttrium aluminum oxide, iron, iron hydroxide, iron hydroxide hydrate, iron oxide, manganese iron oxide, copper iron oxide, zinc iron oxide, nickel zinc iron oxide, copper zinc iron oxide, barium ferrite, alloys of aluminum and iron, or any combination thereof. In some embodiments, the coagulant can comprise, but is not limited to titanium, calcium, zirconium, hydroxides thereof, oxides thereof, oxinates thereof, hydrates thereof, and any combination thereof. For example, the coagulant can comprise titanium oxide (TiO₂), zirconium oxide, calcium oxide, calcium hydroxide, titanium hydroxide, zirconium hydroxide, calcium titanate, or combinations thereof. The coagulant additive can be present in a concentration of 1-30 wt. % by weight of the anode.

The cathode and anode materials can be adhered to the current collector by pressing at, for example, a pressure between 1,000 psi and 20,000 psi (between 6.9×10⁶ and 1.4×10⁸ Pascals). The cathode and anode materials may be adhered to the current collector as a paste. A tab of each current collector extends outside of the device and covers less than 0.2% of the electrode area.

In some embodiments, a separator 9 can be disposed between the anode 13 and the cathode 12 when the electrodes are constructed into the cell or battery 10. While shown as being disposed between the anode 13 and the cathode 12 in FIG. 1A, the separator 9 can be used to wrap one or more of the anode 13 and/or the cathode 12, or alternatively one or more anodes 13 and/or cathodes 12 when multiple anodes 13 and cathodes 12 are present.

The separator 9 may comprise one or more layers. For example, when the separator is used, between 1 to 5 layers of the separator can be applied between adjacent electrodes. The separator can be formed from a suitable material such as nylon, polyester, polyethylene, polypropylene, poly(tetrafluoroethylene) (PTFE), poly(vinyl chloride) (PVC), polyvinyl alcohol, cellulose, or any combination thereof. Suitable layers and separator forms can include, but are not limited to, a polymeric separator layer such as a sintered polymer film membrane, polyolefin membrane, a polyolefin nonwoven membrane, a cellulose membrane, a cellophane, a battery-grade cellophane, a hydrophilically modified polyolefin membrane, and the like, or combinations thereof. As used herein, the phrase “hydrophilically modified” refers to a material whose contact angle with water is less than 45°. In another embodiment, the contact angle with water is less than 30°. In yet another embodiment, the contact angle with water is less than 20°. The polyolefin may be modified by, for example, the addition of TRITON X-100™ or oxygen plasma treatment. In some embodiments, the separator 9 can comprise a CELGARD® brand microporous separator. In an embodiment, the separator 9 can comprise a FS 2192 SG membrane, which is a polyolefin nonwoven membrane commercially available from Freudenberg, Germany. In some embodiments, the separator can comprise a lithium super ionic conductor (LISICON®), sodium super ionic conductions (NASICON), NAFION®, a bipolar membrane, water electrolysis membrane, a composite of polyvinyl alcohol and graphene oxide, polyvinyl alcohol, crosslinked polyvinyl alcohol, or a combination thereof.

An electrolyte (e.g. an alkaline hydroxide, such as NaOH, KOH, LiOH, or mixtures thereof) can be contained within the free spaces of the electrodes 12, 13, the separator 9, and the housing 7. The electrolyte may have a concentration of between 5% and 50% w/w. The electrolyte can be in the form of a liquid and/or gel. For example, the battery 10 can comprise an electrolyte that can be gelled to form a semi-solid polymerized electrolyte. In some embodiments, the electrolyte can be an alkaline electrolyte. The alkaline electrolyte can be a hydroxide such as potassium hydroxide, sodium hydroxide, lithium hydroxide, ammonium hydroxide, cesium hydroxide, or any combination thereof. The resulting electrolyte can have a pH greater than 7, for example between 7 and 15.1. In some embodiments, the pH of the electrolyte can be greater than or equal to 10 and less than or equal to about 15.13.

In addition to a hydroxide, the electrolyte can comprise additional components. In some embodiments, the alkaline electrolyte can have zinc oxide, potassium carbonate, potassium iodide, and/or potassium fluoride as additives. When zinc compounds are present in the electrolyte, the electrolyte can comprise zinc sulfate, zinc chloride, zinc acetate, zinc carbonate, zinc chlorate, zinc fluoride, zinc formate, zinc nitrate, zinc oxalate, zinc sulfite, zinc tartrate, zinc cyanide, zinc oxide, sodium hydroxide, potassium hydroxide, lithium hydroxide, potassium chloride, sodium chloride, potassium fluoride, lithium nitrate, lithium chloride, lithium bromide, lithium bicarbonate, lithium acetate, lithium sulfate, lithium permanganate, lithium nitrate, lithium nitrite, lithium perchlorate, lithium oxalate, lithium fluoride, lithium carbonate, lithium bromate, acrylic acid, N,N′-Methylenebisacrylamide, potassium persulfate, ammonium persulfate, sodium persulfate, or a combination thereof.

In some embodiments, the electrolyte can be an aqueous solution having an acidic or neutral pH. When the electrolyte is acid, the electrolyte can comprise an acid such as a mineral acid (e.g., hydrochloric acid, nitric acid, sulfuric acid, etc.). In some embodiments, the electrolyte solution can comprise a solution comprising potassium permanganate, sodium permanganate, lithium permanganate, calcium permanganate, manganese sulfate, manganese chloride, manganese nitrate, manganese perchlorate, manganese acetate, manganese bis(trifluoromethanesulfonate), manganese triflate, manganese carbonate, manganese oxalate, manganese fluorosilicate, manganese ferrocyanide, manganese bromide, magnesium sulfate, zinc sulfate, zinc triflate, zinc acetate, zinc nitrate, bismuth chloride, bismuth nitrate, nitric acid, sulfuric acid, hydrochloric acid, sodium sulfate, potassium sulfate, sodium hydroxide, potassium hydroxide, titanium sulfate, titanium chloride, lithium nitrate, lithium chloride, lithium bromide, lithium bicarbonate, lithium acetate, lithium sulfate, lithium nitrate, lithium nitrite, lithium hydroxide, lithium perchlorate, lithium oxalate, lithium fluoride, lithium carbonate, lithium sulfate, lithium bromate, or any combination thereof. In some embodiments, the electrolyte can be an acidic or neutral solution, and the pH of the electrolyte can be between 0 and 7.

In some embodiments, the electrolyte can comprise a gassing inhibitor that can coat on metallic anodes surface and reduce or prevent gas formation. In an embodiment, gassing inhibitors can be used that are mixed in with the electrolyte. Suitable gassing inhibitors can include, but are not limited to, indium hydroxide, indium, indium oxide, bismuth oxide, bismuth, carboxymethyl cellulose, polyethylene glycol, zinc oxide, cetyltrimethylammonium bromide, polytetrafluoroethylene, and combinations thereof.

As noted herein, the coagulants can also be included in the electrolyte rather than in the anode, and/or the coagulants can be in both the electrolyte and the anode.

In use, a battery or cell having the coagulants and electrodes as described herein can be constructed and used as a cell. During cycling of the cell, the coagulants can be formed by the passage of electrical current through the cell. The coagulants can then serve to retain the zinc reaction products within the proper location within the cell and help to prevent the zinc reaction products (e.g., zincate ions) from migrating in the cell. For example, the coagulants can help to reduce or prevent the zinc reaction products from migrating to the cathode and/or reallocating within the anode.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

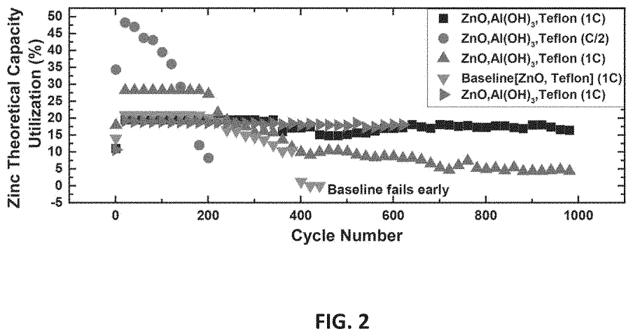

The benefit of adding Al(OH)₃ as an electrocoagulant to the Zn-anode is shown in FIG. 2. In example 1, an electrode is made containing 72.7 wt. % ZnO, 3.6 wt. % Teflon and 23.7 wt. % Al(OH)₃. To test the beneficial effect of adding Al(OH)₃, a baseline electrode was made without containing the electrocoagulant additive and keeping the same binder weight composition i.e, 3.6 wt. % Teflon and 96.4 wt. % ZnO. The anodes were paired with Ni(OH)₂ electrodes in a prismatic cell with vertically aligned electrodes (see FIG. 1) containing 25 wt. % KOH. The baseline electrode was cycled at 1 C at ˜21% utilization of the Zn theoretical capacity (820 mAh/g), which it was able to deliver the without capacity fade for ˜200 cycles and then with constant fade till 450 cycles at which the electrode failed. In comparison, the electrode containing Al(OH)₃ cycled at the similar conditions was able to deliver the complete capacity till ˜320 cycles and then ˜17-19% till 1000 cycles. The slight fade could have been due to loss of active material from the electrode as a result of Zn dissolution in the electrolyte, which is easy to occur in a design containing vertically aligned electrodes as shown in FIG. 1A.

A way to circumvent this issue would be to horizontally align the electrodes as shown in FIG. 1B to prohibit the dissolved Zn ions moving away from the electrode surface. An example of this method is shown in FIG. 2, where the Al(OH)₃ containing electrode, when cycled at similar conditions, is able to deliver the capacity without fade till 600 cycles. The Al(OH)₃ containing electrode was also cycled at higher Zn utilizations of ˜30% and ˜50%, where we see that the capacity retention was better than the baseline electrode and any data reported in literature. Typical composition of the electrodes containing Al(OH)₃ were 72.7 wt. % ZnO, 3.6 wt. % Teflon and 23.7 wt. % Al(OH)₃. The baseline electrodes had a composition of 96.4 wt. % ZnO and 3.6 wt. % Teflon. The electrodes containing Al(OH)₃ were cycled at different Zn utilizations and compared to the baseline electrode cycled at ˜21% of the Zn theoretical capacity of 820 mAh/g. The electrode containing the electrocoagulant additive achieved higher cycle life and better Zn utilizations compared to the baseline.

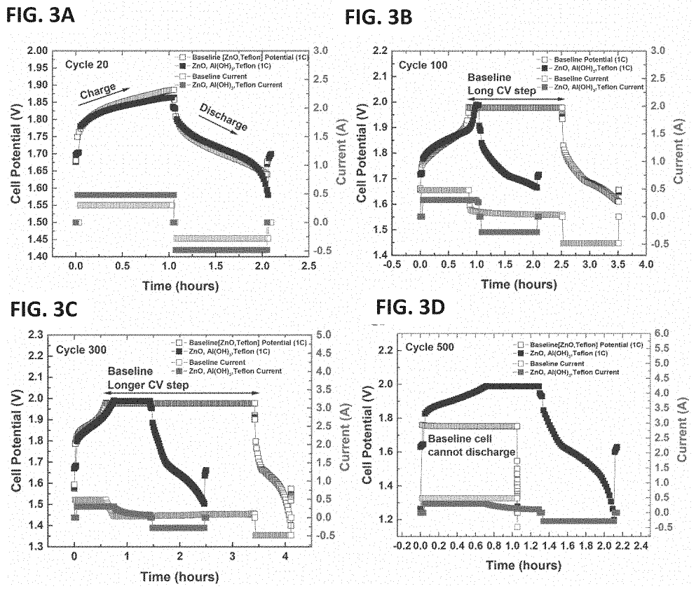

FIGS. 3A, 3B, 3C, and 3D show the potential and current-time characteristics of the baseline electrode and the electrode containing Al(OH)₃ cycled at 21% utilization at cycles 20, 100, 300 and 500, respectively. Cycles 20, 100, 300 and 500 are shown in FIGS. 3A, 3B, 3C, and 3D, respectively. FIG. 3A shows that at the 20^{th} cycle the potential and current-time characteristics of both the electrodes are very similar, where they are able to obtain and deliver the capacity at constant current. In FIG. 3B at the 100^{th} cycle we start seeing differences between the electrodes. The baseline electrode hits the voltage limit during charge and enters into constant voltage mode (˜2 hours) to get its capacity. Zinc plates on the anode during the charging step and, at long constant voltage (CV) times the zinc deposition on the anode is affected, which leads to an undesirable mossy structure that leads to the ultimate failure of the anode. In comparison we see that the electrode containing Al(OH)₃ obtains almost all of its capacity on constant current. In FIGS. 3C and 3D, we see that at the 300^{th} and 500^{th} cycle the baseline electrodes enter into longer constant voltage times during the charging step. At the 500^{th} cycle, almost all of the capacity of the baseline electrode is obtained on constant voltage, which is not a desirable characteristic of any electrode. Longer constant voltage times are also indicative of increasing electrode resistance due to the formation of resistive ZnO during discharge. These are not seen in the electrodes containing Al(OH)₃. The role of Al(OH)₃ is to coagulate with the dissolved zinc ions and prevent it from diffusing away from the vicinity of the electrode. Also, shorter CV times could be indicative of the presence of Al ions in reducing the electrode resistance compared to the baseline electrode.

### Example 2

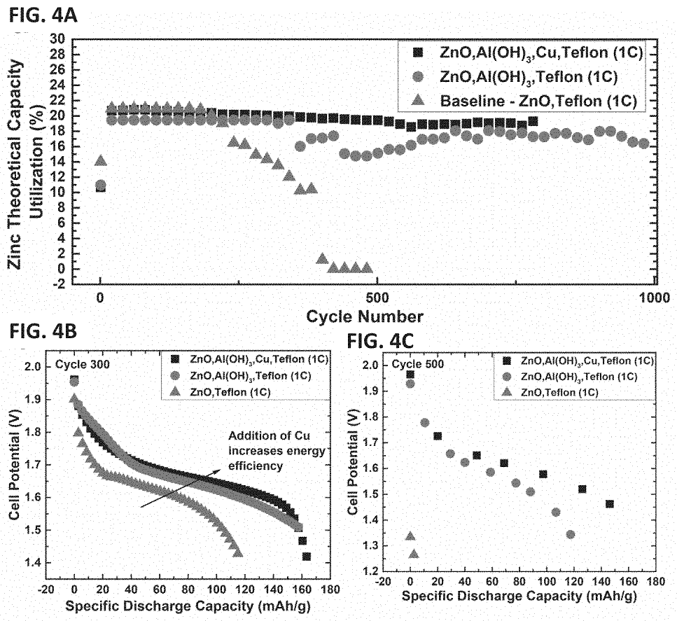

FIGS. 4A, 4B, and 4C contain an example of an electrode containing an electrocoagulant and a conductive metal additive that maintains the high capacity utilization and energy efficiency of the electrode. Cycle life and potential-time curves are shown in FIGS. 4A, 4B, and 4C, respectively, to show the effects of Cu. The electrode containing Cu has a composition of 72.7 wt. % ZnO, 10 wt. % Cu metal powder, 3.6 wt. % Teflon and 13.7 wt. % Al(OH)₃. The baseline electrodes had a composition of 96.4 wt. % ZnO and 3.6 wt. % Teflon. An electrode containing 72.7 wt. % ZnO, 10 wt. % Cu metal powder, 3.6 wt. % Teflon and 13.7 wt. % Al(OH)₃ was made and cycled at 21% utilization at 1 C. This electrode was compared to the electrode containing Al(OH)₃ and the baseline electrode cycled at the similar conditions. FIG. 4A shows that the electrode containing Cu as the conductive metal additive maintains the capacity utilization near 21% for over 750 cycles. FIGS. 4B and 4C show that the voltage efficiency of the electrode containing Cu is improved at the 300 and 500^{th} cycle, which means that the cell is cycling at a higher energy efficiency. A combination of electrocoagulant and metal conductive additives improve the cycling performance of the Zn anodes.

Having described various batteries, systems, and methods, specific aspects can include, but are not limited to:

In a first aspect, a battery comprises: a housing; an electrolyte disposed in the housing; a cathode disposed in the housing; an anode disposed in the housing and comprising an anode material comprising: aluminum, iron, titanium, calcium, zirconium, a hydroxide thereof, a salt thereof, an oxide thereof, or a combination thereof; and a binder.

A second aspect can include the battery of the first aspect, wherein the electrocoagulant material comprises aluminum, an oxide thereof, a hydroxide thereof, or a salt thereof.

A third aspect can include the battery of the first aspect, wherein the electrocoagulant material comprises iron, an oxide thereof, a hydroxide thereof, or a salt thereof.

A fourth aspect can include the battery of any one of the first to third aspects, wherein the anode further comprises a conductive metal additive, and wherein the conductive metal additive is copper, a copper salt, nickel, or a nickel salt.

A fifth aspect can include the battery of the first aspect, wherein the anode further comprises an electrocoagulant additive selected from the group consisting of aluminum, an aluminum salt; iron, an iron salt, and combinations thereof.

A sixth aspect can include the battery of the first aspect, wherein the electrocoagulant additive is aluminum, aluminum hydroxide, aluminum oxide, aluminum oxinate, aluminum monostearate, aluminum hydroxide hydrate, aluminum silicate, bismuth aluminate hydrate, aluminum titanate, strontium aluminate, lithium aluminate, strontium lanthanum aluminate, sodium aluminate and yttrium aluminum oxide, iron, iron hydroxide, iron hydroxide hydrate, iron oxide, manganese iron oxide, copper iron oxide, zinc iron oxide, nickel zinc iron oxide, copper zinc iron oxide, barium ferrite, an alloy of aluminum and iron, titanium, titanium hydroxide, titanium hydroxide hydrate, titanium oxide, calcium, calcium hydroxide, calcium hydroxide hydrate, calcium oxide, zirconium, zirconium hydroxide, zirconium hydroxide hydrate, zirconium oxide, or a combination thereof.

A seventh aspect can include the battery of any one of the first to sixth aspects, further comprising a conductive metal additive, wherein the conductive metal additive is nickel, copper, silver, gold, brass, bronze, cobalt, nickel-cobalt, nickel-copper, bismuth, bismuth oxide, tin, or a combination thereof.

An eighth aspect can include the battery of any one of the first to seventh aspects, wherein the binder comprises a polytetrafluoroethylene, a cellulose-based hydrogel, or a combination thereof.

A ninth aspect can include the battery of the eighth aspect, wherein the binder is a cellulose-based hydrogel selected from the group consisting of methyl cellulose (MC), carboxymethyl cellulose (CMC), hydroxypropyl cellulose (HPC), hydroxypropylmethyl cellulose (HPMC), hydroxyethylmethyl cellulose (HEMC), carboxymethylhydroxyethyl cellulose and hydroxyethyl cellulose (HEC).

A tenth aspect can include the battery of the eighth aspect, wherein the binder is a cellulose-based hydrogel crosslinked with a copolymer selected from the group consisting of polyvinyl alcohol, polyvinylacetate, polyaniline, polyvinylpyrrolidone, polyvinylidene fluoride, and polypyrrole.

An eleventh aspect can include the battery of any one of the first to tenth aspects, wherein the anode comprises 1-30 wt. % of the electrocoagulant material, greater than 0 wt. % and less than or equal to 10 wt. % of a conductive metal additive, and greater than 0 wt. % and less than or equal to 10 wt. % of the binder, and a remainder of the anode as zinc (Zn) or zinc oxide (ZnO).

A twelfth aspect can include the battery of the eleventh aspect, wherein the zinc (Zn) or zinc oxide (ZnO) comprises a gassing inhibitor.

A thirteenth aspect can include the battery of the twelfth aspect, wherein the gassing inhibitor is bismuth or indium compounds in a concentration greater than 0 ppm and less than 1 wt. %.

A fourteenth aspect can include the battery of any one of the first to thirteenth aspects, wherein the anode has a porosity between 5-95%.

A fifteenth aspect can include the battery of any one of the first to fourteenth aspects, wherein the cathode is selected from the group consisting of manganese dioxide (MnO₂), copper intercalated birnessite, birnessite, vanadium oxide, alpha-manganese dioxide, nickel oxyhydroxide (NiOOH), nickel hydroxide (Ni(OH)₂) silver (Ag), copper (Cu), bromine (Br), and air.

A sixteenth aspect can include the battery of any one of the first to fifteenth aspects, further comprising a current collector for the cathode or the anode, the current collector selected from the group consisting of a copper mesh, a copper foil, a nickel mesh, a nickel foil, a copper plated nickel mesh or foil, and a nickel-plated copper mesh or foil.

A seventeenth aspect can include the battery of any one of the first to sixteenth aspects, wherein the anode is formed by pressing electrode material on to a current collector at 1000-20000 psi.

An eighteenth aspect can include the battery of any one of the first to seventeenth aspects, wherein the electrolyte comprises an alkaline hydroxide selected from the group consisting of sodium hydroxide, potassium hydroxide, cesium hydroxide, rubidium hydroxide, lithium hydroxide, or a combination thereof.

A nineteenth aspect can include the battery of any one of the first to eighteenth aspects, further comprising a polymeric separator between the anode and the cathode.

In a twentieth aspect, a battery comprises: a housing; an electrolyte disposed in the housing, wherein the electrolyte comprises an electrocoagulant material selected from the group consisting of: aluminum, iron, titanium, calcium, zirconium, a hydroxide thereof, a salt thereof, an oxide thereof, and a combination thereof; a cathode disposed in the housing; an anode disposed in the housing and comprising an anode material comprising: zinc or zinc oxide; and a binder.

A twenty first aspect can include the battery of the twentieth aspect, wherein the electrocoagulant material comprises aluminum, an oxide thereof, a hydroxide thereof, or a salt thereof.

A twenty second aspect can include the battery of the twentieth aspect, wherein the electrocoagulant material comprises iron, an oxide thereof, a hydroxide thereof, or a salt thereof.

In a twenty third aspect, a method of operating a battery comprises: discharging a battery, the battery comprising: a housing; an electrolyte disposed in the housing; a cathode disposed in the housing; an anode disposed in the housing and comprising an anode material comprising: zinc or zinc oxide; an electrocoagulant material selected from the group consisting of: aluminum, iron, titanium, calcium, zirconium, a hydroxide thereof, a salt thereof, an oxide thereof, and a combination thereof; and a binder; recharging the battery; coagulating one or more reaction products of the zinc or zinc oxide with the electrocoagulant material; and retaining the one or more reaction products of the zinc or zinc oxide at or near the anode during the discharging, recharging, or both using the electrocoagulant material.

A twenty fourth aspect can include the method of the twenty third aspect, wherein the electrocoagulant material comprises aluminum, an oxide thereof, a hydroxide thereof, or a salt thereof.

A twenty fifth aspect can include the method of the twenty third aspect, wherein the electrocoagulant material comprises iron, an oxide thereof, a hydroxide thereof, or a salt thereof.

A twenty sixth aspect can include the method of any one of the twenty third to twenty fifth aspects, wherein the anode further comprises a conductive additive, and wherein the conductive metal additive is copper, a copper salt, nickel, or a nickel salt.

Embodiments are discussed herein with reference to the Figures. However, those skilled in the art will readily appreciate that the detailed description given herein with respect to these figures is for explanatory purposes as the systems and methods extend beyond these limited embodiments. For example, it should be appreciated that those skilled in the art will, in light of the teachings of the present description, recognize a multiplicity of alternate and suitable approaches, depending upon the needs of the particular application, to implement the functionality of any given detail described herein, beyond the particular implementation choices in the following embodiments described and shown. That is, there are numerous modifications and variations that are too numerous to be listed but that all fit within the scope of the present description. Also, singular words should be read as plural and vice versa and masculine as feminine and vice versa, where appropriate, and alternative embodiments do not necessarily imply that the two are mutually exclusive.

It is to be further understood that the present description is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present systems and methods. It must be noted that as used herein and in the appended claims (in this application, or any derived applications thereof), the singular forms “a,” “an,” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this description belongs. Preferred methods, techniques, devices, and materials are described, although any methods, techniques, devices, or materials similar or equivalent to those described herein may be used in the practice or testing of the present systems and methods. Structures described herein are to be understood also to refer to functional equivalents of such structures. The present systems and methods will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims may be formulated in this Application or of any further Application derived therefrom, to particular combinations of features, it should be understood that the scope of the disclosure also includes any novel feature or any novel combination of features disclosed herein either explicitly or implicitly or any generalization thereof, whether or not it relates to the same systems or methods as presently claimed in any Claim and whether or not it mitigates any or all of the same technical problems as do the present systems and methods.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new claims may be formulated to such features and/or combinations of such features during the prosecution of the present Application or of any further Application derived therefrom.

What is claimed is:

1. A battery comprising:
a housing;
an electrolyte disposed in the housing;
a cathode disposed in the housing;
an anode disposed in the housing and comprising an anode material comprising:
zinc or zinc oxide;
an electrocoagulant material selected from the group consisting of: aluminum, iron, titanium, calcium, zirconium, a hydroxide thereof, a salt thereof, an oxide thereof, or a combination thereof; and
a binder.

2. The battery of claim 1, wherein the electrocoagulant material comprises aluminum, an oxide thereof, a hydroxide thereof, or a salt thereof.

3. The battery of claim 1, wherein the electrocoagulant material comprises iron, an oxide thereof, a hydroxide thereof, or a salt thereof.

4. The battery of claim 1, wherein the anode further comprises a conductive metal additive, and wherein the conductive metal additive is copper, a copper salt, nickel, or a nickel salt.

5. The battery of claim 1, wherein the electrocoagulant additive is aluminum, aluminum hydroxide, aluminum oxide, aluminum oxinate, aluminum monostearate, aluminum hydroxide hydrate, aluminum silicate, bismuth aluminate hydrate, aluminum titanate, strontium aluminate, lithium aluminate, strontium lanthanum aluminate, sodium aluminate and yttrium aluminum oxide, iron, iron hydroxide, iron hydroxide hydrate, iron oxide, manganese iron oxide, copper iron oxide, zinc iron oxide, nickel zinc iron oxide, copper zinc iron oxide, barium ferrite, an alloy of aluminum and iron, titanium, titanium hydroxide, titanium hydroxide hydrate, titanium oxide, calcium, calcium hydroxide, calcium hydroxide hydrate, calcium oxide, zirconium, zirconium hydroxide, zirconium hydroxide hydrate, zirconium oxide, or a combination thereof.

6. The battery of claim 1, further comprising a conductive metal additive, wherein the conductive metal additive is nickel, copper, silver, gold, brass, bronze, cobalt, nickel-cobalt, nickel-copper, bismuth, bismuth oxide, tin, or a combination thereof.

7. The battery of claim 1, wherein the binder comprises a polytetrafluoroethylene, a cellulose-based hydrogel, or a combination thereof.

8. The battery of claim 7, wherein the binder is a cellulose-based hydrogel selected from the group consisting of methyl cellulose (MC), carboxymethyl cellulose (CMC), hydroxypropyl cellulose (HPC), hydroxypropylmethyl cellulose (HPMC), hydroxyethylmethyl cellulose (HEMC), carboxymethylhydroxyethyl cellulose and hydroxyethyl cellulose (HEC).

9. The battery of claim 7, wherein the binder is a cellulose-based hydrogel crosslinked with a copolymer selected from the group consisting of polyvinyl alcohol, polyvinylacetate, polyaniline, polyvinylpyrrolidone, polyvinylidene fluoride, and polypyrrole.

10. The battery of claim 1, wherein the anode comprises 1-30 wt. % of the electrocoagulant material, greater than 0 wt. % and less than or equal to 10 wt. % of a conductive metal additive, and greater than 0 wt. % and less than or equal to 10 wt. % of the binder, and a remainder of the anode as zinc (Zn) or zinc oxide (ZnO).

11. The battery of claim 10, wherein the zinc (Zn) or zinc oxide (ZnO) comprises a gassing inhibitor.

12. The battery of claim 11, wherein the gassing inhibitor is bismuth or indium compounds in a concentration greater than 0 ppm and less than 1 wt. %.

13. The battery of claim 1, wherein the anode has a porosity between 5-95%.

14. The battery of claim 1, wherein the cathode is selected from the group consisting of manganese dioxide (MnO₂), copper intercalated birnessite, birnessite, vanadium oxide, alpha-manganese dioxide, nickel oxyhydroxide (NiOOH), nickel hydroxide (Ni(OH)₂) silver (Ag), copper (Cu), bromine (Br), and air.

15. The battery of claim 1, further comprising a current collector for the cathode or the anode, the current collector selected from the group consisting of a copper mesh, a copper foil, a nickel mesh, a nickel foil, a copper plated nickel mesh or foil, and a nickel-plated copper mesh or foil.

16. The battery of claim 1, wherein the electrolyte comprises an alkaline hydroxide selected from the group consisting of sodium hydroxide, potassium hydroxide, cesium hydroxide, rubidium hydroxide, lithium hydroxide or a combination thereof.

17. The battery of claim 1, further comprising a polymeric separator between the anode and the cathode.

18. A battery comprising:
a housing;
an electrolyte disposed in the housing, wherein the electrolyte comprises an electrocoagulant material selected from the group consisting of: aluminum, iron, titanium, calcium, zirconium, a hydroxide thereof, a salt thereof, an oxide thereof, and a combination thereof;
a cathode disposed in the housing;
an anode disposed in the housing and comprising an anode material comprising:
zinc or zinc oxide; and
a binder.

19. The battery of claim 18, wherein the electrocoagulant material comprises aluminum, an oxide thereof, a hydroxide thereof, or a salt thereof.

20. The battery of claim 18, wherein the electrocoagulant material comprises iron, an oxide thereof, a hydroxide thereof, or a salt thereof.

21. A method of operating a battery, the method comprising:
discharging a battery, the battery comprising:
a housing;
an electrolyte disposed in the housing;
a cathode disposed in the housing;
an anode disposed in the housing and comprising an anode material comprising:
zinc or zinc oxide;
an electrocoagulant material selected from the group consisting of: aluminum, iron, titanium, calcium, zirconium, a hydroxide thereof, a salt thereof, an oxide thereof, and a combination thereof; and
a binder;
recharging the battery;
coagulating one or more reaction products of the zinc or zinc oxide with the electrocoagulant material; and
retaining the one or more reaction products of the zinc or zinc oxide at or near the anode during the discharging, recharging, or both using the electrocoagulant material.

22. The method of claim 21, wherein the electrocoagulant material comprises aluminum, an oxide thereof, a hydroxide thereof, or a salt thereof.

23. The method of claim 21, wherein the electrocoagulant material comprises iron, an oxide thereof, a hydroxide thereof, or a salt thereof.

24. The method of claim 21, wherein the anode further comprises a conductive additive, and wherein the conductive metal additive is copper, a copper salt, nickel, or a nickel salt.
